(19) United States
(12) Patent Application Publication
(10) Pub. No.: US 2002/0187234 A1
(43) Pub. Date: Dec. 12, 2002

(54) Food for deep-frying having inner ingredients comprising a foaming ingredient, and a method for the production thereof

(75) Inventors: Norihito Kimizuka, Oura-gun (JP); Toshiyuki Ono, Oura-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AJINOMOTO CO., INC., Tokyo (JP)

(21) Appl. No.: 10/108,568

(22) Filed: Mar. 29, 2002

(30) Foreign Application Priority Data
May 17, 2001 (JP) 2001-147346

(51) Int. Cl. A23L 1/00

(52) U.S. Cl. 426/564

(57) ABSTRACT

The purpose of the present invention is therefore to provide a food for deep-frying, which will rise to the surface of the oil at an appropriate time in deep-frying so as to avoid over-cooking, the excessive decrease in the volume of the inner ingredients, and blowing up phenomena during the deep-frying. Especially, the present invention can effect more advantages when it applies to those with a low shape-stability such as cream croquette and frozen cream croquette.

The present invention relates to a food for deep-frying having inner ingredients comprising a foaming ingredient, and a method for the production thereof.

A food for deep-frying having inner ingredients comprising a foaming ingredient, and a method for the production thereof

### TECHNICAL FIELD OF THE INVENTION

This invention relates to a food for deep-frying, which is easy to handle and hard to blow up or break in a deep-frying process during the steps of the production. This invention is particularly applicable to a food for deep-frying having a low shape-stability such as a cream croquette and a frozen cream croquette.

### PRIOR ART

A food for deep-frying such as a croquette is one of the foods that suit the public taste in a restaurant as well as home. For example, in the cream croquette comprising white source as its inner ingredient, softness of the white sauce and hardness of a batter coating delicately harmonize with each other. And the cream croquette is liked widely due to a smooth feeling in eating of the white sauce of the inner ingredient.

There are various cooking methods for the food for deep-frying. For the croquette, for example, there is a recipe as follows:

“The pre-cooked meat, vegetables, sea-foods and the like, which have been fried, boiled or steamed previously, are mixed with thick white source or strained potato to give inner ingredients (seed material). The inner ingredients thus prepared are shaped into any desired shape or form such as that of oval, straw bag, and leaf, which are easy to eat. They are coated successively with wheat flour, mixed raw egg, and bread crumbs, and are then deep-fried. The batter coating should be thinly and uniformly, and the deep-frying should be carried out quickly in oil at a high temperature. (“Encyclopedia of Cooking Food Materials”, published by Shuhu-no-Tomo Co., the first ed., Jul. 27, 1996, p. 312).

However, the above recipe is just a basic one for the croquettes, and various modification or changes are made to a recipe for the croquettes actually put in the market based on requests in terms of the sense of taste, feeling in eating and handling in eating. Accordingly there are different recipes depending on the kind of the croquettes such as a potato croquette and a cream croquette.

However, the cream croquette has not always risen to the surface of the oil even after an appropriate deep-frying time has passed in a conventional recipe. One of the main reasons is that the cream croquette has a relatively high water content. As a result, it will be hard to observe the condition of the products, and the products will therefore be very likely over-cooked, causing disadvantages such as decrease of the water content of the inner ingredients and an excessive decrease in the volume of the inner ingredients themselves. Furthermore, there will be other disadvantages such as blowing-up with the occurrence of a crack or hole on the surface of the croquette.

In order to avoid the above blowing-up phenomena, the Japanese Patent Application Laid Open Sho.52-44249 discloses a method for the production of a cream croquette which is characterized by adding agar, furcellaran, vegetable gum or lecithin to the inner ingredients of the cream croquette, heating and drying to a creamy state, cooling and allowing to stand still so as to be shaped into a solid form, and finally coating with a batter, followed by deep-frying.

However, the first purpose of the above method is to increase the degree of caking (breaking force) of the inner ingredients of the cream croquette and to decrease the loss of the inner ingredients when they are taken out from a template or coated with the batter. For that purpose to increase the breaking force, a caking or molding material such as agar, which has different physical properties from those of its original ingredients, has to be added. Therefore, once the temperature has become low at the time of eating, those added material will gel and its creamy feeling in eating will be deteriorated. Furthermore, since the products will never rise to the surface of the oil even after the deep-frying has finished with cooking, it has not yet succeeded in solving the problems such as difficulty in observing the condition of the products, and their over-cooking.

In addition, there is disclosed a method to provide a food for deep-frying which is hard to blow up in deep-frying or heating in a microwave oven, which is mixed with an acid oil in water-type emulsion comprising oil and fat, egg yolk treated by an enzyme, methyl cellulose, water (the Japanese Patent Application Laid Open 2001-37425).

However, the purpose of the above method is to stabilize the acid oil in water-type emulsion itself that is contained in the food for deep-frying by using the egg yolk treated by an enzyme for stabilizing the emulsion and using methyl cellulose for stabilizing emulsion and ensuring the shape-stability after heat treatment. Accordingly, there is no disclosure about a food for deep-frying that is not mixed with the acid oil in water-type emulsion, especially no examples about croquettes. The method does never address the problem of rising of the products after deep-frying, and therefore never refer to the technical problems of the difficulty in observing the condition of the products, and their over-cooking.

### PURPOSE OF THE INVENTION

The purpose of the present invention is therefore to provide a food for deep-frying, which will rise to the surface of the oil at an appropriate time in deep-frying so as to avoid over-cooking, the excessive decrease in the volume of the inner ingredients, and blowing-up phenomena during the deep-frying. Especially, the present invention can effect more advantages when it applies to those with a low shape-stability such as cream croquette and frozen cream croquette.

### DISCLOSURE OF THE INVENTION

The present inventors have studied hard to solve the above problems, and finally complete the present invention relating to the food for deep-frying comprising a foaming ingredient.

The present invention therefore relates to a food for deep-frying having inner ingredients comprising a foaming ingredient. This invention also relates to a method for the production of thereof, characterized by comprising the foaming ingredient in the inner ingredients.

### BEST MODE FOR THE INVENTION

The foaming ingredient in the present specification means any ingredient that can generate and keep foaming. Such ingredient per se is well known for those skilled in the art. For example, a foaming aqueous solution containing one or more foaming solute is included in the foaming ingredient. Methyl cellulose, egg white, and an emulsifying agent are preferred examples of the foaming solute in terms of production processes and costs.

There is no limitation with respect to a means for preparing the foaming aqueous solution. Any means well known to those skilled in the art may be used for that purpose, including, for example, “Foam Batter Agitator A510-1.5CI” (manufactured by Satake Chemical Machinery Industry). There is not special limitation about a diameter of air bubble either, but, the air bubble with a diameter of 50 μm or less is preferred because the stability of such foam has become improved.

It is preferred to comprise 0.1-5% by weight of the foaming solute in the inner ingredients in the production of a food for deep-frying of the present invention. With more than 5% by weight of the foaming solute, although a high rising effect of the products may be provided, no preferred taste can be obtained. On the other hand, with less than 0.1% by weight of the foaming solute, a sufficient foaming effect can not be obtained.

Those skilled in the art may optionally control density of the inner ingredients by operating foaming conditions such as temperature and time so as to adjust foaming degree while considering the shape of the food for deep-frying and vaporization quantity of water from the ingredients. As a result, it is possible for those skilled in the art to make the food for deep-frying rise to the surface of oil at an arbitrary time. For example, the density of the inner ingredients is preferably controlled in a range between (ρ−0.05) g/cm³ and (ρ+0.17) g/cm³(“ρ” is the density of oil at the time of deep-frying). The density of the inner ingredients of less than (ρ−0.05) g/cm³ will make the food rise from the beginning of deep-frying, making it difficult to cook uniformly the food for deep-frying and probably causing the blowing-up phenomena. On the other hand, with the density of the inner ingredients of more than (ρ+0.17) g/cm3, the food for deep-frying will probably not rise at an appropriate time.

For example, the density of rape seed oil is 0.85 g/cm³ when it is used for deep-frying at a temperature of 175° C. Accordingly, a food for deep-frying with a higher density than the above value will very likely stay below the surface of the oil, and a food for deep-frying with a lower density than the above value will tend to rise easily from the beginning of the deep-frying. It is therefore possible to make the food for deep-frying rise at an appropriate time by controlling the density of the inner ingredients while considering the shape of the food for deep-frying and the vaporization quantity of water from the ingredients, as already described in the above.

As non-limiting examples of the food for deep-frying of the present invention, there are mentioned a cream croquette, a gratin croquette and a meat croquette. There is no restriction in shape and condition of the food for deep-frying. For example, in the case of a cream croquette, any condition known to those skilled in the art such as frozen or non-frozen state may be accepted, the frozen state being preferred for mass production. In addition, the food for deep-frying of the present invention may be shaped in any form such as coin-shaped (oval), cylindrical, and semi-cylindrical one.

The inner ingredient of the food for deep-frying of the present invention may optionally include any other materials and components publicly known to those skilled in the art, as long as they will not deteriorate the purpose of the present invention.

For example, in the case of a cream croquette, water, dairy product (milk, skim milk), a seasoning or flavor enhancer (salt, sodium glutamate), spice (pepper powder), solid components (mushroom, a cone grain, crab, chicken, finely-cut onion) may be included in the inner ingredients.

Any edible oil and fat suitable for food may be used in the present food for deep-frying, including those which are in a liquid state at a room temperature, such as soybean oil, rape seed oil, corn oil, cotton seed oil, olive oil, peanut oil, rice oil, safflower oil, and sunflower oil, as well as those which are in a solid state at a room temperature, but a liquid state in the deep-frying.

### EXAMPLE

The present invention will be described more in detail by referring to the examples, which should not be construed to limit any technical scope of the present invention.

In addition, the term “% ” means “% by weight” in the present specification, and represents a ratio against the whole inner ingredients.

Margarine (“GT margarine” manufactured by Asahi Denka Kogyo K. K.) 3.0%, rape seed oil (manufactured by Ajinomoto Co., Inc.) 1.0% and finely cut onion 11% were put into a steam jacketed kettle and fried for 10 minutes. Then, white roux (“NZ roux” manufactured by SHIN-NIPPON COMMERCE, INC. (roasted wheat flour 50% oils and fats 50%)) 8.0%, water 30%, skim milk (National Agriculture Co-op) 4.0%, sugar 1.0%, salt 1.5%, MSG (“Ajinomoto” manufactured by Ajinomoto Co., Inc.) 2.0% were further added to the fried materials and heated up to 90° C. with stirring so as to gelatinize the wheat flour (starch). When the temperature reached 90° C., minced crab meat (“Minced Meat” Tomota sailing Co., Ltd.) 15% was added to the resulting material and cooled down to 50° C. The foaming ingredients (density: 0.1 g/cm³ to 1.0 g/ cm³) consisting of water 23% and each foaming solute 0.5% were added to the cooled material to give the inner ingredients for the cream croquette having different density (Example 1:0.79 g/ cm³, Example 2:0.95 cm³, Example 3:1.00 g/cm³).

The resulting inner ingredients were shaped into a semi-cylindrical form (the major axis:8.0 cm, the minor axis:3.0 cm, depth:3.0 cm) in a croquette molding tray, passed through batter liquid, coated with bread crumbs and then frozen to give the cream croquette, which is included in the food for deep-frying according to the present invention.

Methyl cellulose (MS) (“SM4000” manufactured by Shin-Etsu Chemical Industries Co.), fatty acid ester (FE) (“Fry Up” manufactured by Takeda Pharmaceuticals Industries Co.) and the egg white were used as the foaming solute.

After rape seed oil (manufactured by Ajinomoto Co., Inc.) was heated to 175° C., the resulting cream croquettes were deep-fried in the heated salad oil. The density of the salad oil was 0.85 g/cm³ at the time of deep-frying.

On the other hand, a comparative example of the cream croquette was similarly made, while using the inner ingredient (density: 1.03 g/cm³) wherein the foaming solute was replaced by the same amount of water, and subjected to the same deep-frying process.

The results are shown in Table 1 below.

TABLE 1

| | Comparative | Present Invention | | | | | | | | |
|---|---|---|---|---|---|---|---|---|---|---|
| | Example | Example 1 | | | Example 2 | | | Example 3 | | |
| Density of | 1.03 | 0.79 | | | 0.95 | | | 1.00 | | |
| the Inner | | | | | | | | | | |
| Ingredient | | | | | | | | | | |
| Foaming | None | MS | Egg | FE | MS | Egg | FE | MS | Egg | FE |
| Solute | | | White | | | White | | | White | |
| Rising | X | ◯ | ◯ | ◯ | ◯ | ◯ | ◯ | ◯ | ◯ | Δ |
| Blowing | Δ | X | X | X | Δ | Δ | X | ◯ | Δ | X |
| Up | | | | | | | | | | |
| Resistance | | | | | | | | | | |

In the “Rising”:
◯: rising time of less than 5 minutes;
Δ: rising time of more than time five minutes and less than 10 minutes;
X: rising time of more than 10 minutes.
In the “Blowing Up Resistance”:
◯: resistant against blowing up for more than 2 minutes;
Δ: resistant against blowing up for more than one minute and less than 2 minutes;
X: resistant against blowing up for less than one minute.

The results in Table 1 demonstrate that the present invention of each example showed excellent advantages in “Rising” and “Blowing Up Resistance” when compared with the comparative example.

### ADVANTAGES OF THE INVENTION

The present invention provides a food for deep-frying, which will rise to the surface of the oil at an appropriate time in deep-frying so as to avoid over-cooking and blowing up phenomena during the deep-frying.

What is claimed is:

1. A food for deep-frying having inner ingredients comprising a foaming ingredient.

2. A food for deep-frying according to claim 1, wherein the foaming ingredient is a foaming aqueous solution containing a foaming solute.

3. A food for deep-frying according to claim 1 or 2, wherein the foaming solute is at least one selected from the group consisting of Methyl Cellulose (MS), egg white and emulsifying agents.

4. A food for deep-frying according to claim 1 or 2, wherein the inner ingredients comprise 0.1-5% by weight of the foaming solute.

5. A food for deep-frying according to claim 3, wherein the inner ingredients comprise 0.1-5% by weight of the foaming solute.

6. A food for deep-frying according to claim 1 or 2, wherein the density of the inner ingredients is in a range between (ρ−0.05) g/cm³ and (ρ+0.17) g/cm³ (“ρ” is the density of oil at the time of deep-frying).

7. A food for deep-frying according to claim 3, wherein the density of the inner ingredients is in a range between (ρ−0.05) g/cm³ and (ρ+0.17) g/cm³ (“ρ” is the density of oil at the time of deep-frying).

8. A food for deep-frying according to claim 5, wherein the density of the inner ingredients is in a range between (ρ−0.05) g/cm³ and (ρ+0.17) g/cm³ (“ρ” is the density of oil at the time of deep-frying).

9. A croquette having inner ingredients comprising a foaming ingredient.

10. A croquette according to claim 9, wherein the foaming ingredient is a foaming aqueous solution containing a foaming solute.

11. A croquette according to claim 9 or 10, wherein the foaming solute is at least one selected from the group consisting of Methyl Cellulose (MS), egg white and emulsifying agents.

12. A croquette according to claim 9 or 10, wherein the inner ingredients comprise 0.1-5% by weight of the foaming solute.

13. A croquette according to claim 11, wherein the inner ingredients comprise 0.1-5% by weight of the foaming solute.

14. A croquette according to claim 9 or 10, wherein the density of the inner ingredients is in a range between (ρ−0.05) g/cm³ and (ρ+0.17) g/cm³ (“ρ” is the density of oil at the time of deep-frying).

15. A croquette according to claim 11, wherein the density of the inner ingredients is in a range between (ρ−0.05) g/cm³ and (ρ+0.17) g/cm³ (“ρ” is the density of oil at the time of deep-frying).

16. A croquette according to claim 13, wherein the density of the inner ingredients is in a range between (ρ−0.05) g/cm³ and (ρ+0.17) g/cm³ (“ρ” is the density of oil at the time of deep-frying).

17. A cream croquette having inner ingredients comprising a foaming ingredient.

18. A cream croquette according to claim 17, wherein the foaming ingredient is a foaming aqueous solution containing a foaming solute.

19. A cream croquette according to claim 17 or 18, wherein the foaming solute is at least one selected from the group consisting of Methyl Cellulose (MS), egg white and emulsifying agents.

20. A cream croquette according to claim 17 or 18, wherein the inner ingredients comprise 0.1-5% by weight of the foaming solute.

21. A cream croquette according to claim 19, wherein the inner ingredients comprise 0.1-5% by weight of the foaming solute.

22. A cream croquette according to claim 17 or 18, wherein the density of the inner ingredients is in a range between (ρ−0.05) g/cm³ and (ρ+0.17) g/cm³ (“ρ” is the density of oil at the time of deep-frying).

23. A cream croquette according to claim 19, wherein the density of the inner ingredients is in a range between (ρ−0.05) g/cm³ and (ρ+0.17) g/cm³ (“ρ” is the density of oil at the time of deep-frying).

24. A cream croquette according to claim 21, wherein the density of the inner ingredients is in a range between (ρ−0.05) g/cm³ and (ρ+0.17) g/cm³ (“ρ” is the density of oil at the time of deep-frying).

25. A method for the production of thereof, characterized by comprising the foaming ingredient in the inner ingredients.
